(19) United States
(12) Patent Application Publication
(10) Pub. No.: US 2025/0026879 A1
(43) Pub. Date: Jan. 23, 2025

(54) WATER-REPELLENT RESIN AND LIQUID EJECTING HEAD USING THE SAME

(71) Applicant: CANON KABUSHIKI KAISHA, Tokyo (JP)

(72) Inventors: ISAO IMAMURA, Kanagawa (JP); YOHEI HAMADE, Tokyo (JP); SATOSHI TSUTSUI, Kanagawa (JP); MIHO ISHII, Kanagawa (JP); ERIKA MAEDA, Kanagawa (JP)

(21) Appl. No.: 18/768,780

(22) Filed: Jul. 10, 2024

(30) Foreign Application Priority Data
Jul. 12, 2023 (JP) 2023-114341

(51) Int. Cl. C08G 59/17; B41J 2/16

(52) U.S. Cl. CPC C08G 59/1466; B41J 2/1606; B41J 2/162; B41J 2/1631; B41J 2/1603; B41J 2202/03; B41J 2202/22; C08G 2150/00

(57) ABSTRACT

A resin composition contains a cationically curable silicone resin. an epoxy resin. and an acrylic resin. in which the acrylic resin is constituted by an acrylic monomer having an oxygen equivalent of 100 or more.

### BACKGROUND

### Field of the Disclosure

The present disclosure relates to a water-repellent resin and a liquid ejecting head that uses the water-repellent resin in a water-repellent layer.

### Description of the Related Art

A liquid droplet ejecting apparatus such as an ink jet printer ejects droplets of ink or the like from ejection ports of a liquid ejecting member (liquid ejecting head or simply “ejection head”). Electromechanical transducers such as piezoelectric elements are used as the energy-generating elements for ejection. Other known examples of the energy-generating elements include those which generate heat upon irradiation of electromagnetic waves such as a laser beam to cause ejection of ink droplets by the generated heat and those which heat a liquid by using electrothermal transducer elements having heating resistors.

In order to prevent defective ejection and non-ejection caused by the ink remaining on the surfaces of the ejection ports, the peripheries of the ejection ports in the ejection head are subjected to a water-repellent treatment. Examples of the substance that yields this water repellency include fluororesins and silicone resins. A silicone resin does not yield water repellency unless the siloxane chains are sufficiently long; however, the longer the silicone chains, the lower the compatibility with other materials and the more difficult it is to achieve homogeneous mixing. When performing a water-repellent treatment on an ejection head, a silicone resin is mixed with a reactive material, a catalyst, and a photosensitizer to prepare a water repellent, and this water repellent is used for the treatment. Here, only a relatively small amount of the silicone resin can be used to achieve compatibility and obtain a homogeneous water repellent.

Meanwhile, Japanese Patent Laid-Open No. 2019-206636 discloses a resin composition that contains a resin (A) having a polysiloxane unit, an activation energy ray-curable compound (B), and a liquid medium (C). Since the resin (A) also contains a unit that contains hydrophilic epoxy groups and repulsion occurs due to the hydrophilic-hydrophobic interaction between this unit and the hydrophobic polysiloxane unit, the resin (A) easily floats on the outermost surface of a coating film after the coating process. Thus, even when the amount of the silicone resin blended is small, the resistance to contamination and weathering is further improved.

Generally, when epoxy monomers and acrylic monomers are cured in the presence of a cationic polymerization initiator, epoxy monomers undergo cationic polymerization, and acrylic monomers undergo reactions caused by radicals generated in the reaction system. Since the reaction of epoxy monomers and the reaction of acrylic monomers proceed separately, an interpenetrating polymer network (IPN) structure is formed. As a result, lack of toughness specific to an epoxy resin can be compensated by an acrylic resin. In general, in the radical polymerization of an acrylic resin, curing is inhibited by oxygen in air; however, since an epoxy resin is mixed, curing inhibition is reduced.

Furthermore, since some portions of acrylic monomers undergo the reaction independently, the anti-blocking property of the acrylic monomers improves slidability during wiping of the ejection head, and the wear of the water-repellent layer formed on the ejection head can be reduced.

As mentioned above, a silicone-based water-repellent resin has low compatibility and the amount thereof cannot be large if it is to be homogeneously mixed with other resins. Thus, when forming a coating film, a silicone-based water-repellent resin is mixed first in a small amount and then is caused to concentrate on the layer surface side so that the water repellency is exhibited only in the surface and nearby regions thereof. Since the liquid ejecting head is wiped to avoid ink droplets and ink solidification, the surface of the water-repellent layer becomes worn due to wiping during the long-term use, and would no longer repels ink.

Furthermore, when silicone monomers for imparting water repellency are polymerized together with epoxy monomers and acrylic monomers for imparting wear resistance, the compatibility thereof is inherently low, and only a small amount of silicone monomers can be added.

### SUMMARY

The present disclosure provides a resin composition that can maintain satisfactory water repellency during the long-term use, and a liquid ejecting head that uses this resin composition in a water-repellent layer.

The parties involved in the present disclosure have found that the aforementioned issues associated with polymerization of epoxy monomers, acrylic monomers, and silicone monomers for imparting water repellency are addressed by using acrylic monomers having a low oxygen content, by which the compatibility is improved and the amount of the silicone monomers added is increased.

That is, an aspect of the present disclosure relates to a resin composition that contains a silicone resin, an epoxy resin, and an acrylic resin constituted by an acrylic monomer having an oxygen equivalent of 100 or more.

Another aspect of the present disclosure relates to a water-repellent layer composed of the resin composition.

Yet another aspect of the present disclosure relates to a liquid ejecting head that includes the water-repellent layer disposed on at least a periphery of an ejection port.

Further features of the present disclosure will become apparent from the following description of exemplary embodiments with reference to the attached drawings.

### BRIEF DESCRIPTION OF THE DRAWINGS

FIG. 1 is a schematic perspective view of a liquid ejecting head according to one embodiment of the present disclosure.

FIG. 2 is a schematic cross-sectional view illustrating a structure of the liquid ejecting head taken along line II-II in FIG. 1.

FIG. 3A is a cross-sectional view illustrating a step of preparing a substrate, FIG. 3B is a cross-sectional view illustrating a step of forming a layer that will form a nozzle plate material, FIG. 3C is a cross-sectional view illustrating a step of applying and drying a resin composition, FIG. 3D is a cross-sectional view illustrating an exposure step, and FIG. 3E is a cross-sectional view illustrating a step of forming an ejection port and a bubble generating chamber.

### DESCRIPTION OF THE EMBODIMENTS

A resin composition, which is one aspect of the present disclosure, will now be described. This resin composition is obtained by polymerizing silicone monomers, which form a water repellent substance having a siloxane skeleton, together with epoxy monomers and acrylic monomers, and contains a silicone resin, an epoxy resin, and an acrylic resin.

Since patterning performance is necessary to form a water-repellent film while avoiding ejection ports of a liquid ejecting head, a photocationic polymerization initiator is appropriate as a polymerization initiator for polymerizing the monomers. Specific examples of the photocationic polymerization initiator are as follows: aromatic onium salts (see J. POLYMER SCI: Symposium No. 56, 383-395 (1976)), Irgacure (registered trademark) 261 marketed by BASF Japan, SP-150 (trade name), SP-170 (trade name) and SP-172 (trade name) marketed from ADEKA CORPORATION, triazine A, triazine PMS, triazine PP, and triazine B marketed by DKSH Japan K.K., and PHOTO INITIATOR 2074 (trade name) marketed by NIPPON SOLVAY K.K.

It should be noted that a thermal cationic polymerization initiator can be used in combination or alone for portions where an improved crosslink density or patterning is not necessary.

Specific examples of the thermal cationic polymerization initiator include SAN-AID SI-60L (trade name), SAN-AID SI-80L (trade name) and SAN-AID SI-100L (trade name) marketed by SANSHIN CHEMICAL INDUSTRY CO., LTD. Other examples thereof include CP-66 (trade name) and CP-77 (trade name) marketed by ADEKA CORPORATION and a combined use of aromatic onium salts and reducing agents (see Japanese Patent Laid-Open No. 54-102394, and J. POLYMER SCI: Polymer Chemical Edition Vol. 121, 97-109 (1983)).

The epoxy monomer may be any epoxy monomer and may be an alicyclic epoxy monomer having high activity for cations. Examples of the alicyclic epoxy monomer include those which have a dicyclopentadiene skeleton and obtained by epoxidation of a polyhydric alcohol polyglycidyl ether having at least one aliphatic ring, cyclohexene, or a cyclopentene-ring-containing compound with an oxidizing agent. Other examples include epoxy monomers of cyclohexene oxide structure-containing compounds and cyclopentene oxide structure-containing compounds obtained as a result.

Yet other examples include vinylcyclohexane oxide structure-containing compounds obtained by epoxidation of compounds having a vinylcyclohexane structure with an oxidizing agent. Examples of the commercially available products include EHPE-3150 (trade name, produced by Daicel Corporation) and CELLOXIDE 2021 (trade name, produced by Daicel Corporation). From the viewpoint of reactivity, polyfunctional epoxy resins such those of biphenyl type, bisphenol A novolac type, bisphenol F novolac type, and phenol novolac type can also be used. Among these, a dicyclopentadiene-type epoxy resin is preferable for its compatibility. In addition, aliphatic type can be used as necessary.

The acrylic resin forms an interpenetrating polymer network structure together with the epoxy resin, and an acrylic monomer used as a raw material serves as a compatibilizer between the silicone monomer and the epoxy monomer described below.

Thus, in order to enhance compatibility with the silicone monomer, the acrylic monomer may be free of oxygen atoms except for the acrylic moiety, and, in order to enhance compatibility with the epoxy monomer, the hydrocarbon chains of the acrylic monomer may have an appropriate length.

Specifically, an acrylic monomer having an oxygen equivalent of 100 or more is used. When the oxygen equivalent is 100 or more, compatibility with the silicone monomer is improved, the amount of the silicone monomer that can be added can be increased, and concentration of the silicone resin in the surface layer of the resin composition can be avoided. Here, the “oxygen equivalent” is a value obtained by dividing the molecular weight of the acrylic monomer by the number of oxygen atoms contained in the monomer molecule. For example, acrylic acid has a molecular weight of 72.06 and has two oxygen atoms; thus, the oxygen equivalent is 36.03 (approximately 36).

Specific examples of the acrylic monomers having an oxygen equivalent of 100 or more include the followings (the figures in the parentheses indicate oxygen equivalents): isobornyl acrylate (104), isodecyl acrylate (106), lauryl acrylate (120), stearyl acrylate (162), isostearyl acrylate (162), and dicyclopentanyl acrylate (103). In particular, the acrylic monomer can be at least one selected from the group consisting of isobornyl acrylate and dicyclopentanyl acrylate.

Examples of the silicone monomers for yielding water repellency include monomers that have a siloxane structure and are represented by formula (1) below. That is, the compatibility with the epoxy monomer and the acrylic monomer is improved by having an alkyl group at one terminal. The silicone resin after polymerization can be evenly dispersed in the resin composition since a reactive unit is at the other terminal.

Here, when the siloxane structure has about ten repeating units, sufficient water repellency is exhibited, and when the siloxane structure has about eighty repeating units, the compatibility with the composition remains unimpaired.

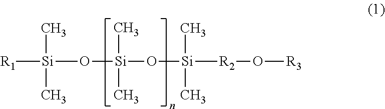

(wherein R₁ represents an alkyl group having 3 to 5 carbon atoms,
R₂ represents an alkylene group having 1 to 5 carbon atoms, R₃ represents at least one of functional groups represented by formulae (2) to (5), and n represents an integer of 10 to 76. )

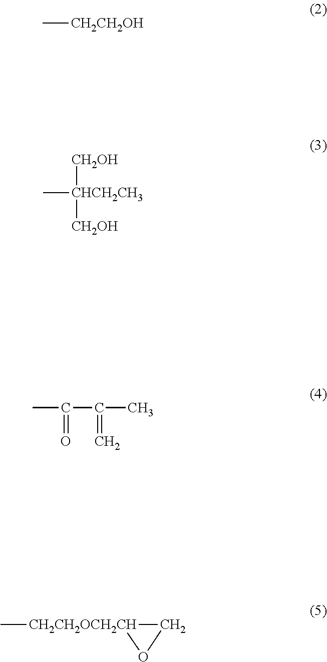

Furthermore, various additives can be used in the resin composition of the present disclosure. Examples of thereof include silane coupling agents that serve as adhesion improvers and compatibilizers. Specific examples of the silane coupling agents include SILQUEST (registered trademark) A-186 and A-187 (produced by Momentive Performance Materials Japan LLC).

The resin composition of the present disclosure can also be used as a water-repellent resin.

The resin composition is obtained by a method that involves adding a cationic polymerization initiator to a mixture containing a silicone monomer, an epoxy monomer, and an acrylic monomer having an oxygen equivalent of 100 or more, and performing photopolymerization and thermal polymerization.

### Liquid Ejecting Head

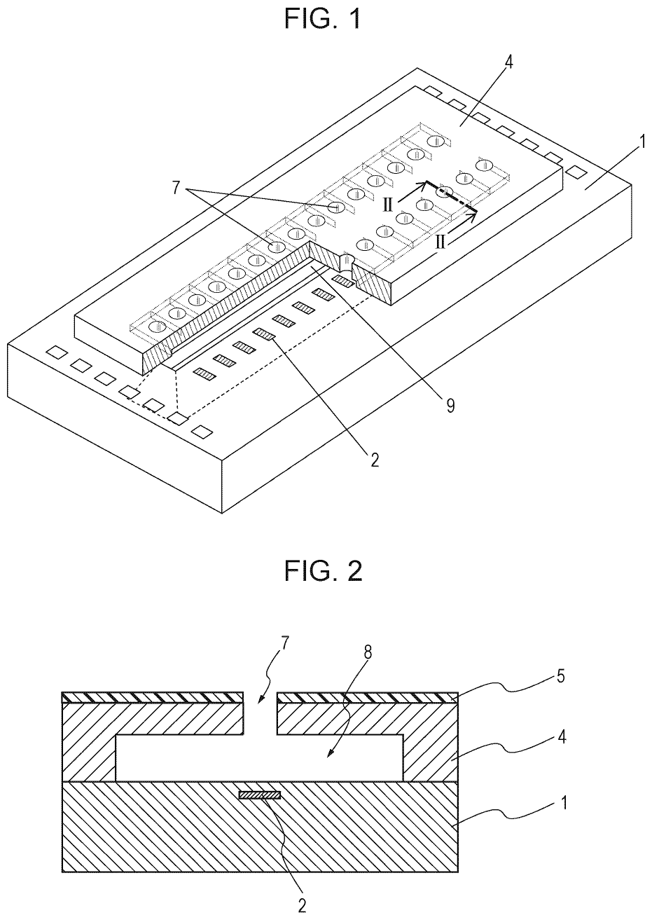

FIG. 1 is a schematic perspective view of a liquid ejecting head according to one embodiment of the present disclosure. FIG. 2 is a schematic cross-sectional view of a structure of the liquid ejecting head taken along line II-II in FIG. 1.

As illustrated in FIGS. 1 and 2, this recording head is equipped with a head substrate 1 (may be simply referred to as a substrate) that has liquid ejecting energy-generating elements 2 that generate energy for ejecting the ink, and a nozzle plate 4 having ejection ports 7 and disposed on the head substrate 1. The recording head is also equipped with bubble generating chambers 8 in communication with the ejection ports 7 and facing the substrate surface in which the liquid ejecting energy-generating elements are formed, and an ink supply port 9 that supplies the ink to the bubble generating chambers 8. The ink supply port 9 penetrates through the substrate 1, and the ink is supplied from a surface of the substrate 1 opposite of the surface on which the nozzle plate 4 is formed. As illustrated in FIG. 2, a water-repellent layer 5 is disposed on an outer surface of the nozzle plate 4, and by decreasing the wettability of the periphery of the ejection port to a liquid, the droplet size, the ejection direction, the ejection speed, and other properties are stabilized, and high definition printing can be performed.

### Method for Producing Liquid Ejecting Head

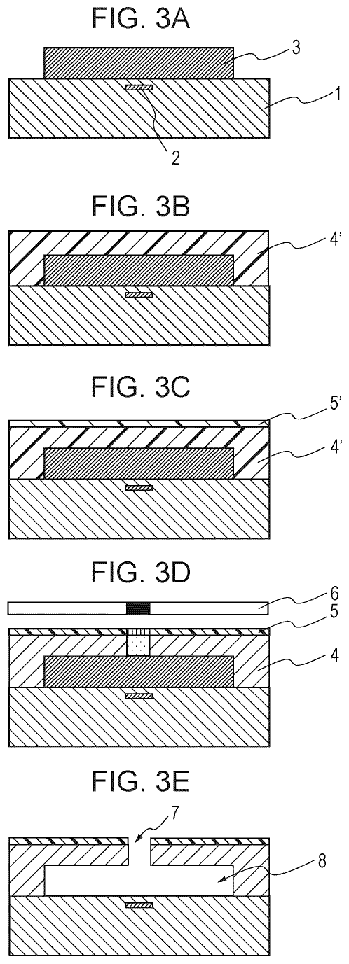

Next, steps for producing the liquid ejecting head according to the present disclosure are described in sequence with reference to FIGS. 3A to 3E.

First, a substrate 1 in which liquid ejecting energy-generating elements 2 are formed as illustrated in FIG. 3A is prepared. The substrate 1 can be a silicon single crystal substrate in which a drive circuit and wiring that connects the drive circuit to the liquid ejecting energy-generating elements can be easily formed. The liquid ejecting energy-generating elements 2 can be of a heater type in which heat is generated by supplying electricity to resistors, or any other elements that can convert electricity into bubble-generating energy. Furthermore, in order to reduce corrosion of the liquid ejecting energy-generating elements 2 caused by the ejected liquid and improve the electrical insulation property, a protection layer (not illustrated) composed of SiO, SiN, tantalum, or the like can be provided in the substrate 1. Here, the protection layer may form the entire surface of the substrate 1. The reason why the liquid ejecting energy-generating elements 2 are illustrated as being embedded in the substrate 1 in FIG. 2, etc., is because the substrate 1 includes this protection layer.

Next, a mold material 3 that can be removed later is formed on the surface of the substrate 1 in which the liquid ejecting energy-generating elements 2 are formed, in particular, on regions that will form liquid flow paths and bubble generating chambers. The material for the mold material is selected in view of the material of the peripheries, and is selected from organic resin materials and metal materials. A positive photosensitive resin can be used as an organic resin material.

Next, as illustrated in FIG. 3B, a layer 4′ that will form a nozzle plate material 4 is formed to cover the substrate 1 and the mold material 3. Both an organic material and an inorganic material can be used for this layer. A negative photosensitive resin can be used in this embodiment since this resin can be subjected to patterning together with a water-repellent layer. The photosensitive resin layer 4′ is formed into a desired thickness.

Next, as illustrated in FIG. 3C, a coating liquid of the resin composition of the present disclosure is applied to cover the photosensitive resin layer 4′ by spin coating or slit coating and dried, or a dry film prepared from this resin composition is laminated by transfer or the like so as to form a water-repellent layer precursor 5′.

Next, pattern exposure is performed through a mask 6 on the photosensitive resin layer 4′ and the water-repellent layer precursor 5′ by using light. An ultraviolet ray can be used as the exposure light; for example, single-wavelength exposure can be performed by using an i-line (365 nm). In the irradiated regions, a nozzle plate material 4 and a water-repellent layer 5 are formed by an acid generated by the photocationic polymerization initiator present in the photosensitive resin layer 4′ and the water-repellent layer precursor 5′ (FIG. 3D). Lastly, the uncured portions and the mold material 3 are removed to form ejection ports 7 and bubble generating chambers 8 (FIG. 3E).

### EXAMPLES

Next, the present disclosure is described through examples and comparative examples. Here, “parts” means parts by mass unless otherwise noted.

### Production of Resin Composition

A method for producing a resin composition involves adding a cationic polymerization initiator to a mixture containing a silicone monomer, an epoxy monomer, and an acrylic monomer having an oxygen equivalent of 100 or more.

In other words, an epoxy monomer, an acrylic monomer, and a silicone monomer were separately weighed, and then were dissolved and mixed. Mixing involved using a stirrer (V-mini 300 produced by EME Inc.) and stirring the mixture in vacuum at a revolution of 1600 rpm and a rotation of 800 rpm for 10 minutes to obtain a monomer composition.

After visually confirming the compatibility of the monomer composition, SP-172 produced by ADEKA CORPORATION was added as a cationic polymerization initiator, the monomer composition was placed on a fluororesin (trade name: Teflon) sheet, and was exposed to light for 33 seconds with a high-pressure mercury lamp at 60 mW. After confirming the cured state, thermal curing was performed at 100° C. for 3 hours to obtain a resin composition. The blends of the components used here are indicated in Tables 1 to 3.

The silicone monomers used in these examples were those represented by formula (1) with R₁ representing CH₃ (CH₂)₃—, R₂ representing —(CH₂)₃—, and R₃ representing a hydroxy group (formula 2) or a dihydroxy group (formula 3). Also used were those represented by formula (1) with R₃ representing a methacrylic group (formula 4)

TABLE 1
Unit: parts

| | | | Oxygen | | | | | | | | | | |
|---|---|---|---|---|---|---|---|---|---|---|---|---|---|
| | Name of material/name | | equiv- | Exam- | Exam- | Exam- | Exam- | Exam- | Exam- | Exam- | Exam- | Exam- | Exam- |
| Classification | of product | | alent | ple 1 | ple 2 | ple 3 | ple 4 | ple 5 | ple 6 | ple 7 | ple 8 | ple 9 | ple 10 |
| Epoxy | Butadiene epoxy/R-45EPT | | | 70 | | | | | | | | | |
| | Dicyclopentadiene | | | | 70 | 70 | 70 | 70 | 70 | | | | |
| | EP/HP7200L | | | | | | | | | | | | |
| | Phenol novolac | | | | | | | | | 70 | 70 | | |
| | EP/jER 152 | | | | | | | | | | | | |
| | Alicyclic | | | | | | | | | | | 70 | 70 |
| | epoxy/EHPE-3158 | | | | | | | | | | | | |
| Acrylic | Acrylic acid | | 36 | | | | | | | | | | |
| | Isobutylene acryl/EP400V | | 5600 | | | | | | | | | | |
| | Dicyclopentadiene/ | | 103 | | | | 60 | 60 | 60 | | 60 | | 60 |
| | FA-513AS | | | | | | | | | | | | |
| | Isobornyl/IBXA | | 104 | 70 | 140 | 140 | 60 | 60 | 60 | 110 | 60 | 70 | 60 |
| Silane agent | Silane agent/A-186 | | | 20 | 20 | 20 | 20 | 20 | 20 | 20 | 20 | 20 | |
| Cationically | Hydroxy group, molecular | | | | | | | | 30 | | | | |
| curable | weight ≈ 1000 | | | | | | | | | | | | |
| silicone | Dihydroxy group, | | | | | | | 30 | | | | | |
| monomer | molecular weight ≈ 1000 | | | | | | | | | | | | |
| | Methacrylic group, | | | 30 | | | 30 | | | | 30 | 30 | 30 |
| | molecular weight ≈ 1000 | | | | | | | | | | | | |
| | Methacrylic group, | | | | | 30 | | | | 30 | | | |
| | molecular weight ≈ 5000 | | | | | | | | | | | | |
| | Methacrylic group | | | | | | | | | | | | |
| | molecular weight ≈ 10000 | | | | | | | | | | | | |
| | Epoxy group molecular | | | | 30 | | | | | | | | |
| | weight ≈ 1000 | | | | | | | | | | | | |
| Photopoly- | 2-Ethylanthraquinone | | | | | | | | | | | | |
| merization | | | | | | | | | | | | | |
| catalyst | | | | | | | | | | | | | |
| Cation | Photocationic | | | 6 | 6 | 6 | 6 | 6 | 6 | 6 | 6 | 6 | 6 |
| initiator | initiator/SP-172 | | | | | | | | | | | | |
| Compatibility | Transparent: ◯ | | | Δ | ∘ | ∘ | ∘ | ∘ | ∘ | ∘ | ∘ | Δ | ∘ |
| | Slight clouding: Δ | | | | | | | | | | | | |
| | Clouding: x, insoluble | | | | | | | | | | | | |
| | or separation: xx | | | | | | | | | | | | |
| Curability | 60 mW | Uncured: — | | Δ | ∘ | ∘ | ∘ | ⊚ | ∘ | ∘ | ∘ | ∘ | ∘ |
| | 33 s | Sticky | | | | | | | | | | | |
| | | surface: Δ | | | | | | | | | | | |
| | | Surface | | | | | | | | | | | |
| | | cured: ◯ | | | | | | | | | | | |
| | 60 mW | Cured: ⊚ | | ⊚ | ⊚ | ⊚ | ⊚ | ⊚ | ⊚ | ⊚ | ⊚ | ⊚ | ⊚ |
| | 33 s + | | | | | | | | | | | | |
| | 100° C. | | | | | | | | | | | | |
| | 3 hr | | | | | | | | | | | | |
| Contact angle | Water | | | 84/83 | 83/83 | 83/84 | 84/84 | 85/85 | 85/84 | 85/84 | 85/85 | 83/83 | 84/84 |
| | Cured surface/rear surface | | | | | | | | | | | | |
| Static | (For high grade paper) | | | 0.41 | 0.24 | 0.23 | 0.24 | 0.18 | 0.23 | 0.31 | 0.29 | 0.32 | 0.29 |
| frictional | | | | | | | | | | | | | |
| coefficient μ | | | | | | | | | | | | | |

≈10000 (n≈131)) or an epoxy group (formula 5).

### Measuring Physical Properties of Resin Composition

The resin composition was separated from the fluororesin sheet, the contact angles of the cured surface and the rear surface thereof (the surface that had been facing the fluororesin sheet surface) were measured, and the static friction coefficient of the cured surface was measured (portable friction meter TYPE: 37i produced by Shinto Scientific Co., Ltd.). The measurement results are altogether indicated in Tables 1 to 3.

TABLE 2
Unit: parts

| | | | Oxygen | Compara- | Compara- | Compara- | Compara- | Compara- | Compara- | Compara- |
|---|---|---|---|---|---|---|---|---|---|---|
| | Name of material/name | | equiv- | tive | tive | tive | tive | tive | tive | tive |
| Classification | of product | | alent | Example 1 | Example 2 | Example 3 | Example 4 | Example 5 | Example 6 | Example 7 |
| Epoxy | Butadiene epoxy/R-45EPT | | | | | | | | | |
| | Dicyclopentadiene | | | | | | | | | |
| | EP/HP7200L | | | | | | | | | |
| | Phenol novolac | | | | | | | | | |
| | EP/jER 152 | | | | | | | | | |
| | Alicyclic | | | | | | | | | |
| | epoxy/EHPE-3158 | | | | | | | | | |
| Acrylic | Acrylic acid | | 36 | 70 | | | | | | |
| | Isobutylene acryl/EP400V | | 5600 | | 70 | | | | | 70 |
| | Dicyclopentadiene/ | | 103 | | | 70 | | | | 30 |
| | FA-513AS | | | | | | | | | |
| | Isobornyl/IBXA | | 104 | | | | 70 | 70 | 70 | |
| Silane agent | Silane agent/A-186 | | | | | | | | | |
| Cationically | Hydroxy group, molecular | | | | | | | | | |
| curable | weight ≈ 1000 | | | | | | | | | |
| silicone | Dihydroxy group, | | | | | | | | | |
| monomer | molecular weight ≈ 1000 | | | | | | | | | |
| | Methacrylic group, | | | 30 | 30 | 30 | 30 | | | 30 |
| | molecular weight ≈ 1000 | | | | | | | | | |
| | Methacrylic group, | | | | | | | 30 | | |
| | molecular weight ≈ 5000 | | | | | | | | | |
| | Methacrylic group | | | | | | | | 30 | |
| | molecular weight ≈ 10000 | | | | | | | | | |
| | Epoxy group molecular | | | | | | | | | |
| | weight ≈ 1000 | | | | | | | | | |
| Photopoly- | 2-Ethylanthraquinone | | | 2 | 2 | 2 | 2 | 2 | 2 | 2 |
| merization | | | | | | | | | | |
| catalyst | | | | | | | | | | |
| Cation | Photocationic | | | | | | | | | |
| initiator | initiator/SP-172 | | | | | | | | | |
| Compatibility | Transparent: ◯ | | | x | Δ | ∘ | ∘ | ∘ | x | ∘ |
| | Slight clouding: Δ | | | | | | | | | |
| | Clouding: x, insoluble | | | | | | | | | |
| | or separation: xx | | | | | | | | | |
| Curability | 60 mW | Uncured: — | | — | Δ | Δ | Δ | Δ | — | Δ |
| | 33 s | Sticky | | | | | | | | |
| | | surface: Δ | | | | | | | | |
| | | Surface | | | | | | | | |
| | | cured: ◯ | | | | | | | | |
| | 60 mW | Cured: ⊚ | | — | Δ | Δ | Δ | Δ | — | Δ |
| | 33 s + | | | | | | | | | |
| | 100° C. | | | | | | | | | |
| | 3 hr | | | | | | | | | |
| Contact angle | Water | | | | | | | | | |
| | Cured surface/rear surface | | | | | | | | | |
| Static | (For high grade paper) | | | | | | | | | |
| frictional | | | | | | | | | | |
| coefficient μ | | | | | | | | | | |

HP7200L produced by DIC Corporation
jER 152 produced by Mitsubishi Chemical Group Corporation
EHPE-3150 produced by Daicel Corporation
EP400V produced by KANEKA CORPORATION
FA-513AS produced by Resonac Holdings Corporation
IBXA produced by OSAKA ORGANIC CHEMICAL INDUSTRY LTD.

TABLE 3
Unit: parts

| | | | | Compara- | Compara- | Compara- | Compara- | Compara- | Compara- | Compara- | Compara- |
|---|---|---|---|---|---|---|---|---|---|---|---|
| | | | Oxygen | tive | tive | tive | tive | tive | tive | tive | tive |
| | Name of material/name | | equiv- | Example | Example | Example | Example | Example | Example | Example | Example |
| Classification | of product | | alent | 8 | 9 | 10 | 11 | 12 | 13 | 14 | 15 |
| Epoxy | Butadiene epoxy/R-45EPT | | | 70 | 70 | | | | | | |
| | Dicyclopentadiene | | | | | 70 | | | | | |
| | EP/HP7200L | | | | | | | | | | |
| | Phenol novolac | | | | | | 70 | | | | 99 |
| | EP/jER 152 | | | | | | | | | | |
| | Alicyclic | | | | | | | 70 | 70 | 70 | |
| | epoxy/EHPE-3158 | | | | | | | | | | |
| Acrylic | Acrylic acid | | 36 | | | | | | | | |
| | Isobutylene acryl/EP400V | | 5600 | | | | | | | | |
| | Dicyclopentadiene/ | | 103 | | | | | | | | |
| | FA-513AS | | | | | | | | | | |
| | Isobornyl/IBXA | | 104 | | | | | | | | |
| Silane agent | Silane agent/A-186 | | | | 20 | 20 | 20 | 20 | 20 | 20 | 20 |
| Cationically | Hydroxy group, molecular | | | | | | | | | 30 | |
| curable | weight ≈ 1000 | | | | | | | | | | |
| silicone | Dihydroxy group, | | | 30 | 30 | 30 | 30 | 30 | | | 1 |
| monomer | molecular weight ≈ 1000 | | | | | | | | | | |
| | Methacrylic group, | | | | | | | | 30 | | |
| | molecular weight ≈ 1000 | | | | | | | | | | |
| | Methacrylic group, | | | | | | | | | | |
| | molecular weight ≈ 5000 | | | | | | | | | | |
| | Methacrylic group | | | | | | | | | | |
| | molecular weight ≈ 10000 | | | | | | | | | | |
| | Epoxy group molecular | | | | | | | | | | |
| | weight ≈ 1000 | | | | | | | | | | |
| Photopoly- | 2-Ethylanthraquinone | | | | | | | | | | |
| merization | | | | | | | | | | | |
| catalyst | | | | | | | | | | | |
| Cation | Photocationic | | | 6 | 6 | 6 | 6 | 6 | 6 | 6 | 60 |
| initiator | initiator/SP-172 | | | | | | | | | | |
| Compatibility | Transparent: ◯ | | | xx | xx | xx | xx | xx | xx | xx | Δ |
| | Slight clouding: Δ | | | | | | | | | | |
| | Clouding: x, insoluble | | | | | | | | | | |
| | or separation: xx | | | | | | | | | | |
| Curability | 60 mW | Uncured: — | | | — | — | — | — | — | — | ∘ |
| | 33 s | Surface | | | | | | | | | |
| | | stickiness: Δ | | | | | | | | | |
| | | Surface | | | | | | | | | |
| | | cured: ◯ | | | | | | | | | |
| | 60 mW | Cured: ⊚ | | | — | — | — | — | — | — | ⊚ |
| | 33 s + | | | | | | | | | | |
| | 100° C. | | | | | | | | | | |
| | 3 hr | | | | | | | | | | |
| | [symbol] | | | | | | | | | | |

[symbol]

indicates data missing or illegible when filed

In Examples 1 to 10 described above, since the acrylic monomer having an oxygen equivalent of 100 or more was used, the silicone monomer and the epoxy monomer could be evenly mixed and the cationic polymerization was performed. As a result, the silicone resin could be incorporated into the interpenetrating polymer network (IPN) structure composed of the epoxy resin and the acrylic resin.

Due to these features, 10 mass % or more of the water repellent silicone resin could be incorporated into the resin composition, and the water repellent silicone resin could be evenly distributed throughout the resin composition. As a result, the silicone resin was contained not only in the surface but also in the inside of the layer and the rear surface of the layer, and the water repellency could be maintained over a long term despite wiping.

Comparative Example 15 described below showed that a large amount of the silicone resin could not be mixed. The result showed that the only portion that exhibited water repellency was the surface.

Focusing on the static friction coefficient, the value was as low as 0.18 to 0.41 according to the present disclosure while the value was 0.8 in Comparative Example 15, which was about three times the value of the present disclosure. This was because the acrylic monomer having an oxygen equivalent of 100 or more was used in the present disclosure, and thus the cationically curable silicone resin was evenly dispersed in the resin composition. This was also because excellent slidability was offered by the anti-blocking performance specific to the acrylic resin.

In Example 5, a dicyclopentadiene epoxy resin and a dihydroxy-type silicone resin were used in combination, and this combination had high reactivity and curing occurred even in the inside at the time of UV irradiation. Furthermore, the static friction coefficient, which is an indicator of the anti-blocking performance specific to the acrylic resin, was the lowest.

In Comparative Examples 1 to 4, the compatibility and the reactivity between the acrylic monomer and the silicone monomer were confirmed. In Comparative Example 1 where the oxygen equivalent of the acrylic monomer was low, the acrylic monomer and the silicone monomer were not compatible due to high polarity.

In Comparative Example 2 where the oxygen equivalent was 5600, the compatibility was achieved with slight clouding. This was presumably because the acrylic monomer had an excessively high molecular weight and was in a polymer state. Comparative Examples 3 to 5 where the oxygen equivalent was about 100 showed that the monomers were satisfactorily mixed.

Thus, as long as the oxygen equivalent is 100 or more, the acrylic monomers and oligomers are satisfactorily mixed. Moreover, even when the acryl is close to polymer, mixing and curing is possible. The upper limit of the oxygen equivalent is not particularly limited and can be, for example, 6000 or less.

In Comparative Examples 4 to 6, the compatibility of the silicone monomer with the acrylic monomer according to the molecular weight of the silicone monomer was confirmed. It is demonstrated that compatibility was exhibited up to a molecular weight of 5000 but not at a molecular weight of 10000.

In Comparative Examples 1 and 6, the silicone monomer and the acrylic monomer were not compatible and the reaction did not proceed.

In Comparative Examples 2 to 5 and 7, the silicone monomer and the acrylic monomer were compatible and underwent reaction, but the reactivity of the silicone monomer was low. Furthermore, due to the radical polymerization reaction, the influence of the oxygen inhibition was prominent, and stickiness remained as a result.

In Comparative Examples 8 to 15, the compatibility between the epoxy monomer and the silicone monomer was confirmed. Since most epoxy monomers were highly viscous or solid, an alicyclic silane coupling agent highly reactive to cationic polymerization initiators was added in these comparative examples except for Comparative Example 8.

In Comparative Examples 8 to 14, no compatibility was exhibited, and thus the mixtures were in a gel state.

In Comparative Example 15, since the amount of the silicone monomer was small, curing was possible but with slight clouding. The contact angles of the cured surface/rear surface were 85/60, and it was considered that the cationically curable silicone resin was concentrated in the cured surface. The static friction coefficient μ for the high-grade paper was 0.8.

### Comparative Test

Example 7 and Comparative Example 15 in which the contact angles of the cured surfaces were about the same were subjected to a blade resistance test.

Each of the resins was applied to a silicon wafer by spin coating to 10 μm, exposed to light at 60 mW for 33 seconds, and then thermally cured at 100° C. for 3 hours.

Next, wiping was performed in a dry state by using a rubber blade composed of HNBR and having a rubber hardness of 70 and a thickness of 1 mm, at an indentation of 1 mm and a speed of 80 mm/s. The resin was microscopically observed every 50 wipes.

In Comparative Example 15, wear in the surface was observed after 50 wipes, but in Example 9, no changes were observed up to 1500 wipes.

This confirms that a resin composition that exhibits satisfactory water repellency during the long-term use is obtained by performing cationic polymerization using a highly compatible acrylic monomer having an oxygen equivalent of 100 or more for both the epoxy monomer and the silicone monomer. Furthermore, by using the acrylic monomer having an oxygen equivalent of 100 or more, a cationically curable silicone resin can be incorporated into the interpenetrating polymer network structure composed of the epoxy resin and the acrylic resin.

In this manner, the reactivity is high, the wiping resistance is high, and satisfactory water repellency is maintained due to the cationically curable silicone resin incorporated throughout the composition.

The present disclosure includes the following features.
Feature 1: A resin composition containing a cationically curable silicone resin, an epoxy resin, and an acrylic resin,
   in which the acrylic resin is constituted by an acrylic monomer having an oxygen equivalent of 100 or more.
Feature 2: The resin composition described in feature 1, in which the cationically curable silicone resin is constituted by a cationically curable silicone monomer, and the cationically curable silicone monomer is a siloxane monomer represented by formula (1):

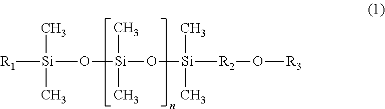

(wherein R₁ represents an alkyl group having 3 to 5 carbon atoms,
R₂ represents an alkylene group having 1 to 5 carbon atoms, R₃ represents at least one of functional groups represented by formulae (2) to (5), and n represents an integer of 10 to 76. )

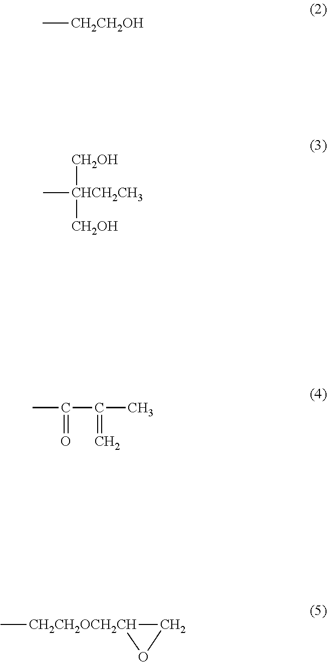

Feature 3: The resin composition described in feature 1 or 2, in which the silicone resin accounts for 10 mass % or more of the resin composition.
Feature 4: The resin composition described in any one of features 1 to 3, in which the acrylic monomer having an oxygen equivalent of 100 or more is at least one selected from the group consisting of isobornyl acrylate and dicyclopentanyl acrylate.
Feature 5: The resin composition described in any one of features 1 to 4, in which the epoxy resin is constituted by an epoxy monomer having a dicyclopentadiene skeleton.
Feature 6: A water-repellent resin that includes the resin composition described in any one of features 1 to 5.
Feature 7: A liquid ejecting head in which the resin composition described in any one of features 1 to 5 is disposed on a surface in a periphery of an ejection port by patterning.

The present disclosure also includes the following method.
Method 1: A method for producing the resin composition described in any one of features 1 to 5, the method causing a mixture containing a silicone monomer, an epoxy monomer, and an acrylic monomer having an oxygen equivalent of 100 or more by using a cationic polymerization initiator.

A resin composition that can maintain satisfactory water repellency during the long-term use and a liquid ejecting head that uses this resin composition in a water-repellent layer can be obtained.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-114341, filed Jul. 12, 2023, which is hereby incorporated by reference herein in its entirety.

What is claimed is:

1. A resin composition comprising:
a cationically curable silicone resin;
an epoxy resin; and
an acrylic resin,
wherein the acrylic resin is constituted by an acrylic monomer having an oxygen equivalent of 100 or more.

2. The resin composition according to claim 1, wherein the cationically curable silicone resin is constituted by a cationically curable silicone monomer, and
the cationically curable silicone monomer is a siloxane monomer represented by formula (1): 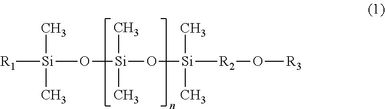
wherein R₁ represents an alkyl group having 3 to 5 carbon atoms,
R₂ represents an alkylene group having 1 to 5 carbon atoms,
R₃ represents at least one of functional groups represented by formulae (2) to (5), and
n represents an integer of 10 to 76:

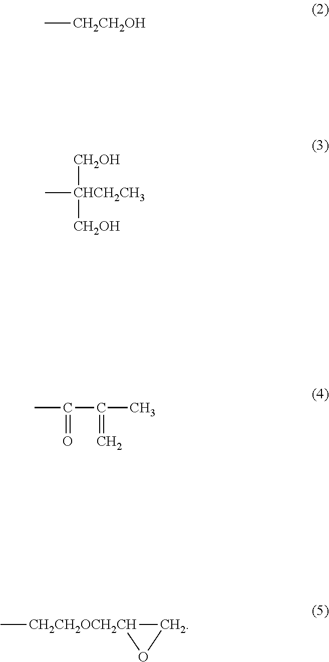

3. The resin composition according to claim 1, wherein the silicone resin accounts for 10 mass % or more of the resin composition.

4. The resin composition according to claim 1, wherein the acrylic monomer having an oxygen equivalent of 100 or more is at least one selected from the group consisting of isobornyl acrylate and dicyclopentanyl acrylate.

5. The resin composition according to claim 1, wherein the epoxy resin is constituted by an epoxy monomer having a dicyclopentadiene skeleton.

6. A water-repellent resin comprising:
a resin composition containing:
a cationically curable silicone resin,
an epoxy resin, and
an acrylic resin,
wherein the acrylic resin is constituted by an acrylic monomer having an oxygen equivalent of 100 or more.

7. A liquid ejecting head comprising:
a member having an ejection port; and
a resin composition that contains a cationically curable silicone resin, an epoxy resin, and an acrylic resin constituted by an acrylic monomer having an oxygen equivalent of 100 or more, and that is disposed on at least a surface of the member in a periphery of the ejection port by patterning.

8. A method for producing a resin composition that contains a cationically curable silicone resin, an epoxy resin, and an acrylic resin constituted by an acrylic monomer having an oxygen equivalent of 100 or more, the method comprising:
causing a mixture containing a silicone monomer, an epoxy monomer, and an acrylic monomer having an oxygen equivalent of 100 or more to react by using a cationic polymerization initiator.
